(19) United States
(12) Patent Application Publication
(10) Pub. No.: US 2008/0001711 A1
(43) Pub. Date: Jan. 3, 2008

(54) RELIABILITY OF EXECUTION FOR DEVICE PROVIDER IMPLEMENTATIONS

(75) Inventors: Abhishek Agarwal, Hyderabad (IN); Anush Kumar, Seattle, WA (US); Balasubramanian Sriram, Sammamish, WA (US); Mohamed Fakrudeen Ali Ahmed, Coimbatore (IN); Janaki Ram Goteti, Hyderabad (IN); Jayaram Kalyana Sundaram, Hyderabad (IN); Kalyan Chakravarthy Sonnathi, Hyderabad (IN); Ramachandran Venkatesh, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/460,809

(22) Filed: Jul. 28, 2006

(30) Foreign Application Priority Data
Jun. 15, 2006 (IN) 1427/DEL/2006

(51) Int. Cl. H04Q 5/22

(52) U.S. Cl. 340/10.1; 340/572.1; 709/249; 709/250; 709/203

(57) ABSTRACT

The claimed subject matter provides a system and/or a method that facilitates providing reliability associated with radio frequency identification (RFID) technology. An RFID network can include at least one device that wirelessly receives data from a tag. A provider component can have a dedicated execution space independent of an RFID server within a host allowing communication to at least one device within the RFID network.

### CROSS REFERENCE TO RELATED APPLICATION(S)

This application claims the benefit of India Patent Application Serial No. 1427/DEL/2006 filed on Jun. 15, 2006, entitled “RELIABILITY OF EXECUTION FOR DEVICE PROVIDER IMPLEMENTATIONS.” The entirety of which application is incorporated herein by reference.

### BACKGROUND

Many retail, manufacture, and distribution establishments are applying different and innovative operating methods to increase efficiency. These establishments can monitor store inventory to facilitate optimizing supply and demand relating to consumers. One aspect of maximizing profit hinges on properly stocking inventory such that replenishment occurs in conjunction with exhaustion of goods and/or products. For example, a retailer selling a computer and/or a VCR, must stock the computer in relation to its consumer sales, and the VCR in relation to its consumer sales. Thus, if the computer is in higher demand (e.g. more units sold) than the VCR, the retailer can stock the computer more frequently in order to optimize supply and demand, and in turn, profit. Monitoring inventory and associated sales can be a complex task, wherein product activity is comparable to a black box since inner workings are unknown; yet monitoring products is a crucial element in inventory/product efficiency.

Automatic identification and data capture (AIDC) technology, and specifically, Radio Frequency Identification (RFID) has been developed based at least upon the need to cure deficiencies of typical monitoring systems and/or methodologies (e.g., barcode readers, barcodes, and/or UPCs). RFID is a technique of remotely storing and retrieving data utilizing RFID tags. Since RFID systems are based upon radio frequency and associated signals, numerous benefits and/or advantages precede traditional techniques in monitoring products. RFID technology does not require a line of sight in order to monitor products and/or receive signals from RFID tags. Thus, no manual scan is necessary wherein the scanner is required to be in close proximity of the target (e.g., product). Yet, range is limited in RFID based upon radio frequency, RFID tag size, and associated power source. Additionally, RFID systems allow multiple reads within seconds providing quick scans and identification. In other words, an RFID system allows a plurality of tags to be read and/or identified when the tags are within a range of an RFID reader. The capability of multiple reads in an RFID system is complimented with the ability of providing informational tags that contain a unique identification code to each individual product.

Moreover, RFID systems and/or methodologies provide real-time data associated to a tagged item. Real-time data streams allow a retailer, distributor, and/or manufacturer the ability to monitor inventory and/or products with precision. Utilizing RFID can further facilitate supplying products on a front-end distribution (e.g., retailer to consumer) and a back-end distribution (e.g. distributor/manufacturer to retailer). Distributors and/or manufacturers can monitor shipments of goods, quality, amount, shipping time, etc. In addition, retailers can track the amount of inventory received, location of such inventory, quality, shelf life, etc. The described benefits demonstrate the flexibility of RFID technology to function across multiple domains such as, front-end supply, back-end supply, distribution chains, manufacturing, retail, automation, etc.

An RFID system consists of at least an RFID tag and an RFID transceiver. The RFID tag can contain an antenna that provides reception and/or transmission to radio frequency queries from the RFID transceiver. The RFID tag can be a small object, such as, for example, an adhesive sticker, a flexible label and integrated chip, etc. There are typically four different frequencies the RFID tags utilize: low frequency tags (between about 125 to 134 kilohertz), high frequency tags (about 13.56 megahertz), UHF tags (about 868 to 956 megahertz) and Microwave tags (about 2.45 gigahertz).

In general, an RFID system can include multiple components: tags, tag readers (e.g. tag transceivers), tag writers, tag-programming stations, circulation readers, sorting equipment, tag inventory wands, etc. Such devices and, in general, RFID systems are exposed to security threats, faults, etc. based solely on the characteristics which out-perform traditional and/or conventional systems. The RFID systems and devices are vulnerable and would be inept albeit for measures associated therewith. With the growth of RFID systems, and in particular RFID devices, enhancing and improving reliability and/or robustness is an increasing concern to protect the quality and integrity of such devices and systems.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate dedicating execution space for a provider related to a device. A provider component can utilize a dedicated execution space (e.g., sandboxed) within a host that includes an RFID server. The provider component can communicate with various devices within an RFID network, such as a device and a tag that wirelessly communicate data. The device that receives data from a tag within the RFID network can be, but is not limited to being, an RFID reader, an RFID writer, an RFID printer, a printer, a reader, a writer, an RFID transmitter, an antenna, a sensor, a real-time device, an RFID receiver, a real-time sensor, a device extensible to a web service, and a real-time event generation system. By allowing the provider component to utilize isolated and dedicated execution space, any errors, crashes, corruption, timeouts, etc. can be isolated to the provider component and not affect the host and/or RFID server.

In accordance with one aspect of the claimed subject matter, a dedicated thread can also be employed when control is transferred from the server code to the provider code. The server threads may not be used to call into the provider to isolate any possible vulnerability to such provider. Once control is transferred, the dedicated thread can be monitored for any timeouts and/or responsiveness. When the dedicated thread for the provider is unresponsive, a timeout exception can be thrown and the dedicated thread can be abandoned. By utilizing the dedicated thread, deadlock scenarios can be handled where user code calls back into the server and attempts to take a lock through a call that has already been taken. Moreover, this can be mitigated by the various components holding as granular locks as possible.

In accordance with another aspect of the innovation described herein, the provider component can be implemented by independent hardware vendor, wherein the provider component can be loaded within the host to allow communication with the device. For example, the provider component can be associated with a particular make, model, function, type, version, size, classification, serial number, and/or any other suitable distinction with respect to the devices. Thus, each provider component can be given dedicated execution space to deal with respective devices within the respective RFID network. In other aspects of the claimed subject matter, methods are provided that facilitates dedicating execution space for a provider related to a device.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates dedicating execution space for a provider related to a device.

FIG. 2 illustrates a block diagram of an exemplary system that facilitates hosting a provider of devices in a dedicated execution space.

FIG. 3 illustrates a block diagram of an exemplary system that facilitates dedicating execution space for a plurality of providers that relate to devices within an RFID network.

FIG. 4 illustrates a block diagram of an exemplary system that facilitates employing a dedicated provider thread that is monitored by an RFID server.

FIG. 5 illustrates a block diagram of an exemplary system that facilitates configuring an RFID device within an RFID network.

FIG. 6 illustrates a block diagram of an exemplary system that facilitates dedicating execution space for a provider related to a device.

FIG. 7 illustrates an exemplary methodology for hosting a provider of devices in a dedicated execution space.

FIG. 8 illustrates an exemplary methodology for dedicating execution space for a plurality of providers that relate to devices within an RFID network.

FIG. 9 illustrates an exemplary methodology that facilitates employing a dedicated provider thread that is monitored by an RFID server.

FIG. 10 illustrates an exemplary networking environment, wherein the novel aspects of the claimed subject matter can be employed.

FIG. 11 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “interface,” “server,” “host,” “manager,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

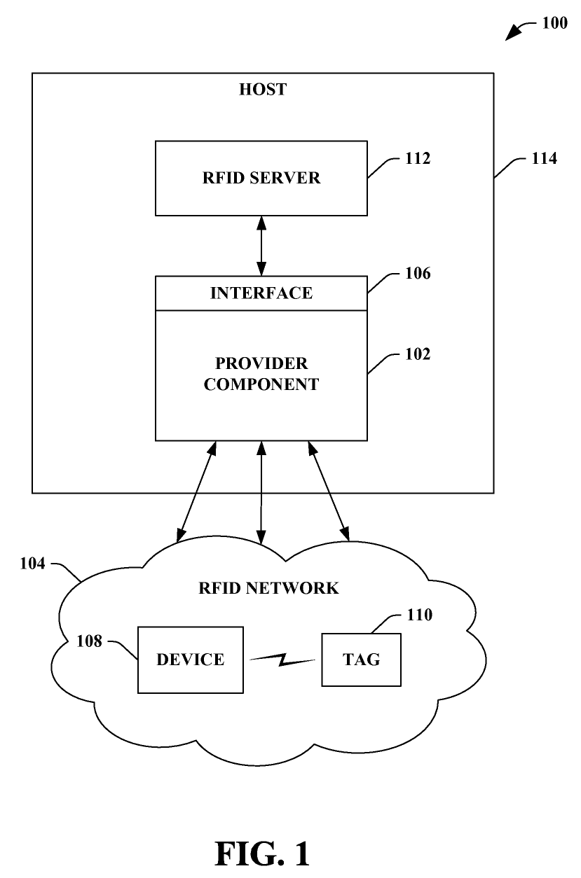

Now turning to the figures, FIG. 1 illustrates a system 100 that facilitates dedicating execution space for a provider related to a device. The system 100 can include a provider component 102 that can be “sandboxed” and/or have independent/dedicated execution space in comparison with an RFID server 112 and a host 114. By utilizing independent execution space for the provider component 102, reliability of the host 114 and the RFID server 112 can be improved. The provider component 102 can employ communications to an RFID network 104 that includes at least one device 108 receiving data from a tag 110. In particular, the provider component 102 can be implemented by independent hardware vendor, wherein the provider component 102 can be loaded within the host 114 to allow communication with the device 108. For example, the provider component 102 can be associated with a particular make, model, function, type, version, size, classification, serial number, and/or any other suitable distinction with respect to the devices 108. Thus, each provider component 102 can be given dedicated execution space to deal with respective devices 108 within the respective RFID network 104.

By sandboxing each provider component 102, the host 114 and the RFID server 112 can be protected and/or isolated from any crashes, errors, corruption, timeouts, etc. related to the provider component 102. In other words, when the provider component 102 has dedicated execution space, any corruption and/or problems associated therewith will not affect the host 114 and/or the RFID server 112. Conventionally, a server and/or host would crash since the application and/or service is running in the same execution space regardless of the error, crash, timeout, corruption, etc. On the contrary, by sandboxing each provider component 102 within the system 100, reliability and robustness is improved for the RFID server 112 and/or the host 114. In addition, the provider component 102 can utilize a dedicated thread that is monitored by the RFID server 112 for a timeout, an error, a corruption, etc.

The provider component 102 can communicate to the RFID network 104 to utilize the device 108. It is to be appreciated that the device 108 can receive a signal from, for instance, at least one tag 110 and/or a plurality of tags. In one example, the tag 110 can contain an antenna that provides reception and/or transmission to radio frequency queries from the device 108. Furthermore, it is to be appreciated that the device 108 within the RFID network 104 can be, but is not limited to being, an RFID reader, an RFID writer, an RFID printer, a printer, a reader, a writer, an RFID transmitter, an antenna, a sensor, a real-time device, an RFID receiver, a real-time sensor, a device extensible to a web service, and a real-time event generation system. Additionally, although a single device 108 and tag 110 are depicted, it is to be appreciated that a plurality of devices 108 and tags 110 can be utilized with the system 100.

In one example, the RFID network 104 can include at least one device 108 that is associated with at least one RFID process (not shown). It is to be appreciated that the RFID process can utilize any suitable number of devices 108 within the RFID network 104. An RFID process can be related to a particular RFID sub-system (e.g., the RFID server 112, the host 114, RFID network, etc.) that is an uber or high-level object that forms together various entities to create a meaningful unit of execution. The RFID process can be and/or can include an outbound process (e.g., pick, pack, shipping scenario, etc.), a manufacturing process, a shipping process, a receiving process, tracking, data representation, data manipulation, data application, security, etc. Additionally, the RFID process can include and/or respond to a device service, a tag read, an event, a tag write, a device configuration, a geographic tracking, a number count, etc. It is to be appreciated that the process can have raw data collected via at least one device associated with the RFID network 104, wherein such raw data can be manipulated based at least in part upon a rule and/or a business rule engine (not shown).

Moreover, the system 100 can include any suitable and/or necessary interface component 106 (herein referred to as “interface 106”), which provides various adapters, connectors, channels, communication paths, etc. to integrate the provider component 102 into virtually any operating and/or database system(s). In addition, the interface 106 can provide various adapters, connectors, channels, communication paths, etc., that provide for interaction with the provider component 102, the RFID network 104, the RFID server 112, the host 114, and any other device and/or component associated with the system 100.

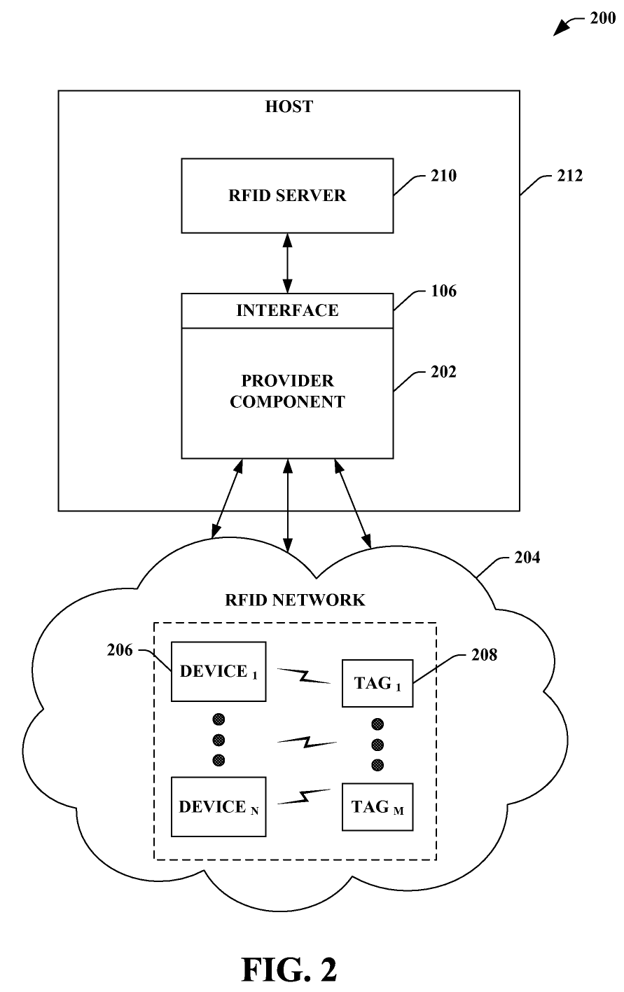

FIG. 2 illustrates a system 200 that facilitates hosting a provider of devices in a dedicated execution space. The system 200 can include a provider component 202 that has an independent execution domain to improve reliability and/or robustness of a host 212 including an RFID server 210. The provider component 202 can communicate with a device 206 within an RFID network 204. Each provider component 202 can be sandboxed at a granular-provider-level in order to contain errors, corruption, timeouts, crashes, etc. to the particular provider component 202. In other words, for each device some provider component must be utilized to communicate therewith; thus each provider has its own dedicated execution domain and/or space. For example, if there are five different devices that have five disparate provider components, there can be five dedicated execution spaces and/or domains respectively. Moreover, the RFID server 210 within the host 212 can provide a dedicated provider thread for the provider component 202 such that the RFID server threads are not used to call into the provider component 202. It is to be appreciated and understood that the provider component 202, the RFID network 204, the device 206, a tag 208, the RFID server 210, the interface 106 and the host 212 can be substantially similar to the components, networks, devices, tags, servers, interfaces and hosts described in FIG. 1.

The RFID network 204 can be implemented by any enterprise, business, facility, and/or any suitable entity that can utilize RFID technology. For instance, the RFID network 204 can be deployed to include any number of devices 206 such as device ₁ to device _{N}, where N is positive integer. Moreover, such devices 206 can interact (e.g., wirelessly communicate) with any number of tags 208 such as tag ₁ to tag _{M}, where M is a positive integer. It is to be appreciated that the devices 206 can be at least one of the following: an RFID reader, an RFID writer, an RFID printer, an RFID transmitter, a sensor, a real-time device, an RFID receiver, a real-time sensor, a device extensible to a web service, a real-time event generator, etc. In addition, the device 206 can be associated with at least an antenna to communicate data. Furthermore, it is to be appreciated that the tags 208 can be associated to any suitable object related to the enterprise, business, facility, and/or any suitable entity utilizing such RFID technology.

The devices 206 can be associated with at least one RFID process (not shown). It is to be appreciated that the RFID process can run in the same host (e.g., host 212) as the provider component 202. It is to be appreciated that a plurality of RFID processes can be executed utilizing the host 212 in conjunction with the RFID network 204. The RFID network 204 can include various sub-systems and/or groups based at least in part upon device location, device functionality, device security level, process device association, make and/or model of device, type of device, device frequency, etc. For example, an RFID network 204 can include two groups and/or collections of devices, one at a shipping door and another at a receiving door. Such RFID network 204 can further include a process associated with each groups and/or collection of devices. For instance, the process can be a shipping process that is related to the devices at the shipping door, wherein the devices can collect data at such location. Similarly, another process can be a receiving process that is related to the devices at the receiving door, wherein the devices can collect data at such location.

Furthermore, the RFID process can be a business process, wherein the devices 206 can be indirectly utilized in association with the business process (not shown). In an example, the RFID stack can bridge the gap between devices 206 and business applications. The business process can be, for instance, a business application to achieve a critical business function. For instance, the business application can be a back end application, an existing business application, a line of business (LOB) application, an accounting application, a supply chain management application, a resource planning application, and/or a business monitoring (BAM) application. In addition, the critical business function can be, for example, a demand plan, a forecast, and/or an inventory control with the incorporation of RFID data in real-time. In another example, an RFID host associated with the RFID network 204 can utilize a business rules engine (not shown), wherein such business rules engine can provide a rule-based system in association with any application related to the RFID network 204 such that a filter and/or alert can be utilized as a rule(s). The business rules engine can execute declarative filters and/or alerts as rules associated with an RFID network 204, wherein the rules can include a rule set adhered to an event, condition, and action format utilizing an extensible markup language (XML). The rule is at least one of the following: contained within a rule set that adheres to an event, a condition, and an action; and represented utilizing an extensible markup language (XML). Moreover, the condition has at least one of a set of predicates and a logical connective to form a logical expression that evaluates to one of a true and a false.

The process can be an uber and/or high-level object that can provide a meaningful unit of execution. For instance, the process can be a shipping process that represents multiple devices at various dock doors working together to perform tag reads, filtering, read enrichment, alert evaluation, and data storage in a sink for a host application to retrieve/process. In another example, the process can execute a manufacturing process, wherein devices are configured to read as well as write dependent upon a location. Moreover, additional functions such as filtering, alerting, enriching, etc. can be implemented at the location. In yet another example, the process can write to a tag process, wherein a tag can be written in real-time based at least upon an input. The write process can also check if the write succeeded by reading and passing data back to the host 212.

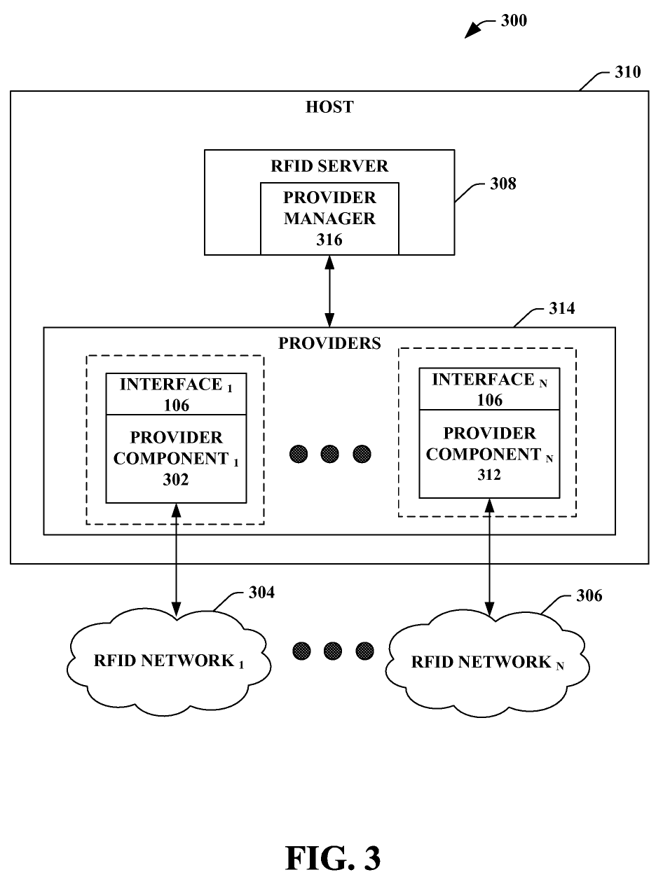

FIG. 3 illustrates a system 300 that facilitates dedicating execution space for a plurality of providers that relate to devices within an RFID network. The system 300 can allow a group of providers 314 (e.g., that include a provider component ₁ 302) to each independently utilize a dedicated execution space in relation to an RFID server 308 and a host 310. The providers 314 can provide communication to at least one device (not shown) within an RFID network ₁ 304. The system 300 allows each of the plurality of providers 314 to confide in an isolated execution domain to improve reliance, robustness, security, and integrity of the RFID server 308 and host 310. It is to be appreciated that the provider component ₁ 302, the host 310, the RFID server 308, the RFID network ₁ 304, and the interface 106 can be substantially similar to the components, servers, hosts, networks, and interfaces described in previous figures.

It is to be appreciated that there can be any number of provider components that communicate with devices based on the device subscription to such providers. For instance, a provider component can be deployed for each device(s) subscribed therewith such as provider component ₁ 302 (with interface ₁) for the RFID network ₁ 304 (having provider-related devices) to provider component _{N} 312 (with interface _{N}) for the RFID network _{N} 306, where N is a positive integer. By utilizing a distinct and independent execution space for each provider component, the RFID server 308 and the host can be isolated from any provider errors, corruptions, infections, timeouts, crashes, etc. In other words, the provider components are sandboxed within the host 310 to allow productive and reliable communication between the RFID server 308 and/or the provider manager 316.

The RFID server 308 can further include a provider manager 316 that can communicate with the plurality of providers 314. As stated above, each provider component ₁ 302 to provider component _{N} 312 can utilize a dedicated, distinct, and separate execution space in comparison with one another and the RFID server 308 and the host 310. It is to be appreciated that such dedicated execution space can be illustrated by the dotted-lines surrounding the provider components. The provider manager 316 can manage the plurality of providers 314 by employing dedicated threads to each of the providers, wherein such threads can be monitored and/or pinged to prevent faults, errors, timeouts, corruption, etc.

The following is an example of the claimed subject matter, wherein such example is not to be seen as limiting on the subject innovation. The example can have numerous modifications, nuances, etc., yet it is to be appreciated and understood that such minor changes/or manipulations are to be within the scope of the claimed subject matter. The RFID server 308 can talk to devices via provider components ₁ 302 to provider components _{N} 312. The provider components can be dynamic-link library (DLL) files that can be written by, for instance, a device independent hardware vendor. The provider components can be faulty, or in general, less robust than the RFID server 308. To make the RFID server 308 more reliable in the face of faulty providers, the following can be implemented: 1) host each provider component in its own process; and 2) utilize a dedicated provider thread to transfer control from the server code to the provider code. By hosting each provider component in its own process, this can ensure that if a provider component goes down, the RFID server 308 does not go down but rather only the provider component's process is recycled. Utilizing a dedicated provider thread never requires a server thread to be called into the provider component. Instead, the RFID server 308 can transfer control to the dedicated provider thread, and monitor the thread. If the thread does not return within a certain amount of time, the thread can be abandoned and a timeout exception can be thrown.

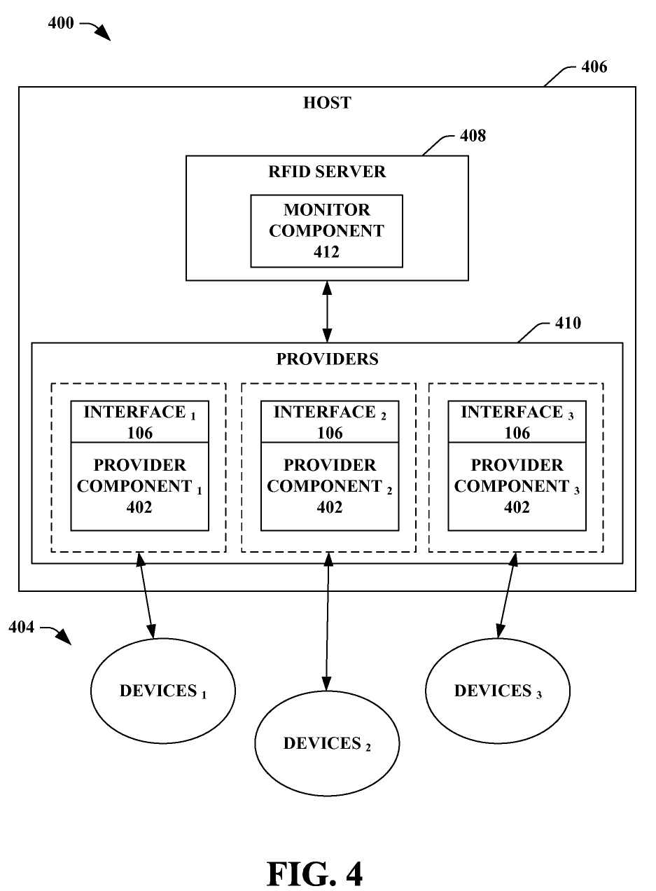

FIG. 4 illustrates a system 400 that facilitates employing a dedicated provider thread that is monitored by an RFID server. The system 400 can include a host 406 that hosts an RFID server 408 and providers 410, wherein the providers 410 can be individually sandboxed to improve reliability of the host 406. The providers 410 can provide communication and/or talk to a plurality of devices 404 to allow interaction with the RFID server 408. The RFID server 408 can further utilize a dedicated thread to transfer control from the RFID server 408 to the one of the providers 410 (discussed infra).

In an example, the providers 410 can include a provider component ₁ 402, a provider component ₂ 402, and a provider component ₃ 402, wherein each provider component can be a disparate provider that utilizes particular DLLs written by a device independent hardware vendor. Thus, a provider component ₁ 402 can communicate and/or service a sub-group of the plurality of devices depicted as devices ₁, the provider component ₂ 402 can communicate and/or service a sub-group of the plurality of devices depicted as devices ₂, and the provider component ₃ 402 can communicate and/or service a sub-group of the plurality of devices depicted as devices ₃. In other words, each provider component can be contained within its own execution domain in order to decrease the vulnerability of the RFID server 408 and/or host 406.

The RFID server 408 can employ a dedicated thread to a particular provider within the providers 410 when control is transferred from the server code to the particular provider code. In other words, the server threads are never used to call into the provider. Instead, they transfer control to the dedicated thread from which the particular provider can utilize. The RFID server 408 can include a monitor component 412 that can watch and/or monitor the dedicated thread. For instance, if the thread does not return (e.g., response, ping, etc.) within a certain amount of time, the dedicated thread can be abandoned and a timeout exception can be thrown. It is to be appreciated that the monitor component 412 can utilize any suitable technique and/or manner to ensure the dedicated thread is responsive. By employing the above, deadlock scenarios where user code calls back into the RFID server 408 and attempts to take a lock through a call (e.g., a WS call) that has already been taken can be solved. This problem can be further mitigated by the various components holding as granular locks as possible.

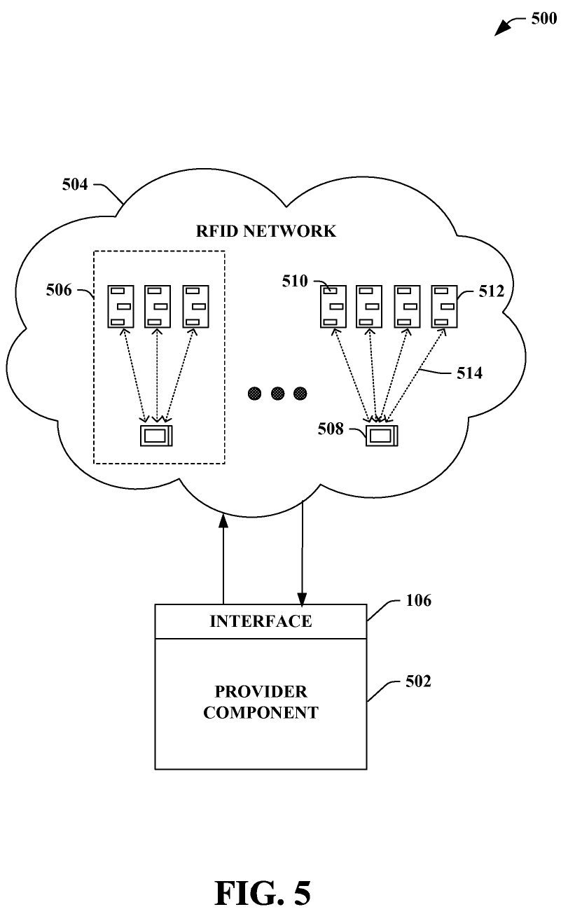

FIG. 5 illustrates a system 500 that facilitates configuring an RFID device within an RFID network. The system 500 can include provider component 502 that communicates to devices by implementing DLLs written by the device independent hardware vendors. The provider component 502 can be isolated in a dedicated execution space and/or sandboxed to allow any faults, errors, corruptions, timeouts, etc. to be maintained within such space as to not affect any other component, server, host, etc. associated with the system 500. Furthermore, it is to be appreciated that the provider component 502 and the RFID network 504 can be substantially similar to previously described figures.

The RFID network 504 can include a plurality of universes (e.g., sub-systems, RFID networks), wherein a universe is a server of RFID entities. For simplicity, the RFID network 504 illustrates a single universe containing two collections of devices (e.g. device collections), where a first collection 506 is shown. It is to be appreciated that the device collections can correspond to device groups, wherein such collections and/or groups can be based on at least one of the following: device physical location, device functionality, device security level, process device association, make and/or model of device, type of device, device frequency, etc. In an example, the device groups and/or collections can communicate to a particular provider (not shown). For instance, an RFID sub-system can be a location wherein the entities involved are related to a substantially similar process. In one example, a sub-system can be a warehouse containing a plurality of receiving and/or shipping dock doors with associated devices. Thus, first collection 506 can be a collection of devices within the specified sub-system. It is to be appreciated a plurality of collection of devices can be implemented. Within a collection of devices, a device 508 can receive an RFID signal 514 from a pallet of goods 512 containing at least one RFID tag 510. It is to be appreciated the pallets and/or goods can be tagged based at least upon user specifications (e.g., single pallets tagged, individual goods tagged, pallets and goods tagged, etc.).

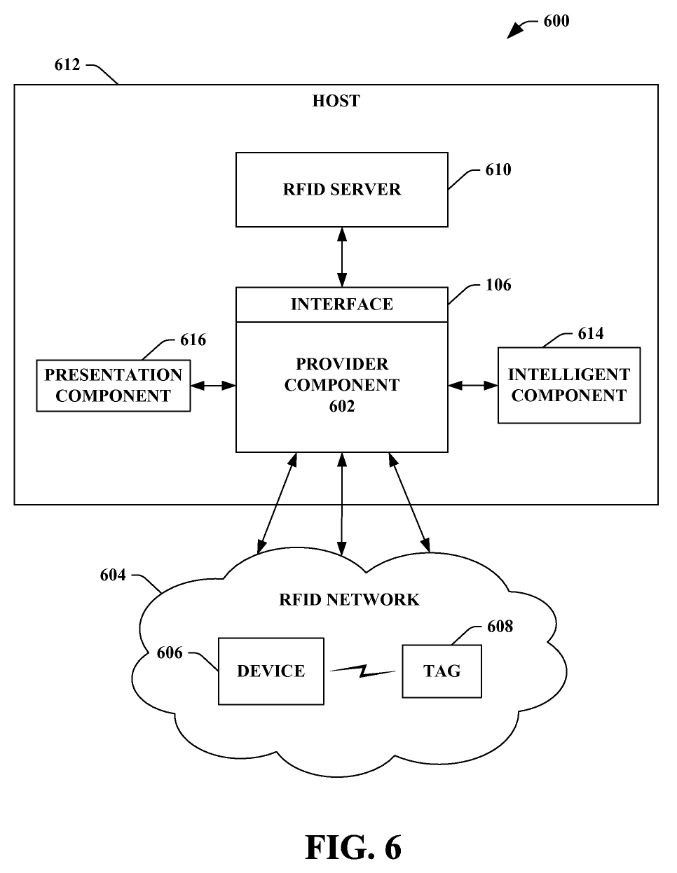

FIG. 6 illustrates a system 600 that employs intelligence to facilitate dedicating execution space for a provider associated with a device. The system 600 can include a provider component 602, an RFID network 604, a device 606, a tag 608, an RFID server 610, and the interface 106 that can all be substantially similar to respective components, servers, networks, devices, tags, hosts, and interfaces described in previous figures. The system 600 further includes an intelligent component 614. The intelligent component 614 can be utilized by the provider component 602 to facilitate ensuring reliability utilizing dedicated execution space for the provider component 602. For example, the intelligent component 614 can infer the amount of dedicated provider execution space necessary, the amount of providers, dedicated threads, amount of dedicated thread, monitoring of the dedicated provider thread, timeouts related to the dedicated thread, possible timeouts, etc.

It is to be understood that the intelligent component 614 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

The provider component 602 can further utilize a presentation component 616 that provides various types of user interfaces to facilitate interaction between a user and any component coupled to the provider component 602. As depicted, the presentation component 616 is a separate entity that can be utilized with the provider component 602. However, it is to be appreciated that the presentation component 616 and/or similar view components can be incorporated into the provider component 602 and/or a stand-alone unit. The presentation component 616 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the provider component 602.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

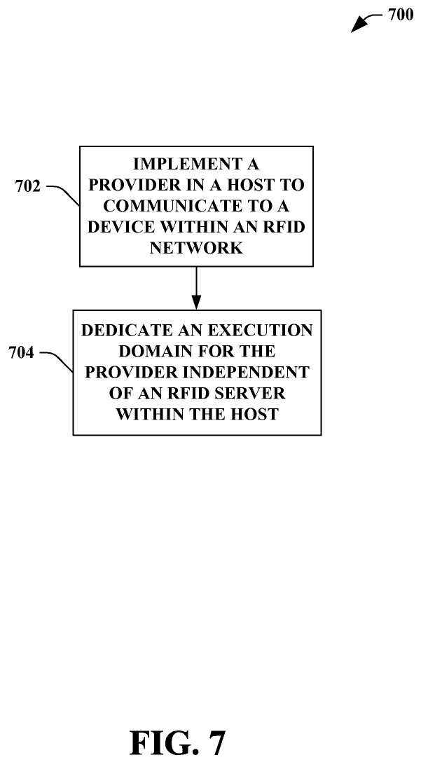

FIGS. 7-9 illustrate methodologies in accordance with the claimed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates a methodology 700 that facilitates hosting a provider of devices in a dedicated execution space. At reference numeral 702, a provider within a host can be implemented such that the provider can communicate to a device within an RFID network (e.g., a physical architecture of devices). The device can receive a signal from, for instance, at least one tag and/or a plurality of tags. In one example, the tag can contain an antenna that provides reception and/or transmission to radio frequency queries from the device. Furthermore, it is to be appreciated that the device within the RFID network can be, but is not limited to being, an RFID reader, an RFID writer, an RFID printer, a printer, a reader, a writer, an RFID transmitter, an antenna, a sensor, a real-time device, an RFID receiver, a real-time sensor, a device extensible to a web service, and a real-time event generation system.

The RFID network can include at least one device that is associated with at least one RFID process. It is to be appreciated that the RFID process can utilize any suitable number of devices within the RFID network. An RFID process can be related to a particular RFID sub-system (e.g., an RFID server, RFID network, etc.) that is an uber or high-level object that forms together various entities to create a meaningful unit of execution. The RFID process can be an outbound process (e.g. pick, pack, shipping scenario, etc.), a manufacturing process, a shipping process, a receiving process, tracking, data representation, data manipulation, data application, security, etc.

At reference numeral 704, an execution domain can be dedicated to the provider independent of an RFID server within the host. By dedicating execution space to the provider, the host and the RFID server can be protected and/or isolated from any crashes, errors, corruption, timeouts, etc. related to the provider. In other words, when the provider is isolated within the provider's own independent execution domain, any corruption and/or problems associated therewith will not affect the host and/or the RFID server. In particular, the provider can be implemented by independent hardware vendor, wherein the provider can be loaded within the host to allow communication with the device. Thus, each provider can be given dedicated execution space to deal with respective devices within the respective RFID network.

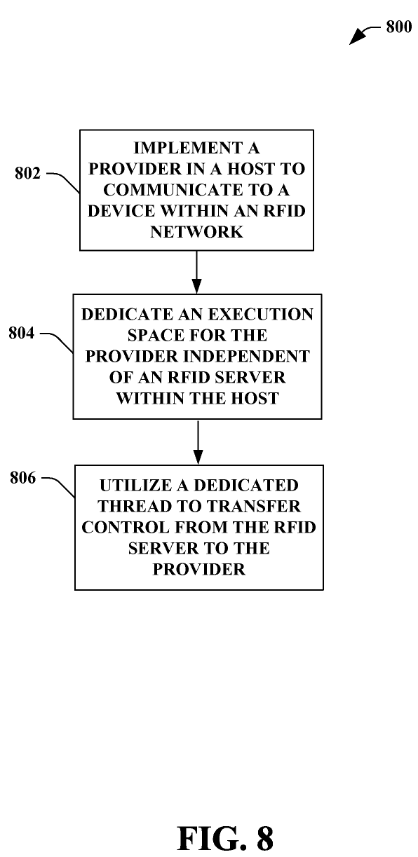

FIG. 8 illustrates a methodology 800 for dedicating execution space for a plurality of providers that relate to devices within an RFID network. At reference numeral 802, a provider can be implemented within a host to communicate to a device within an RFID network. It is to be appreciated that the device within the RFID network can be, but is not limited to being, an RFID reader, an RFID writer, an RFID printer, a printer, a reader, a writer, an RFID transmitter, an antenna, a sensor, a real-time device, an RFID receiver, a real-time sensor, a device extensible to a web service, and a real-time event generation system. At reference numeral 804, an execution space can be dedicated for the provider independent of an RFID server within the host. By hosting each provider within its process, this can ensure that if the provider goes down, the RFID server will not go down. For instance, if the provider goes down (e.g. error, timeout, crash, corrupt, blue screen, etc.), only the provider process can be recycled.

At reference numeral 806, a dedicated thread to transfer control from the RFID server to the provider can be utilized. In other words, whenever control is transferred from the server code to the provider code, the dedicated thread can be used. Thus, the server threads may not be used to call into the provider. For instance, the dedicated thread can protect server threads by calling into user code through such dedicated threads. By isolating the provider and utilizing the dedicated thread, the host and/or RFID server are less vulnerable to faults associated with the providers.

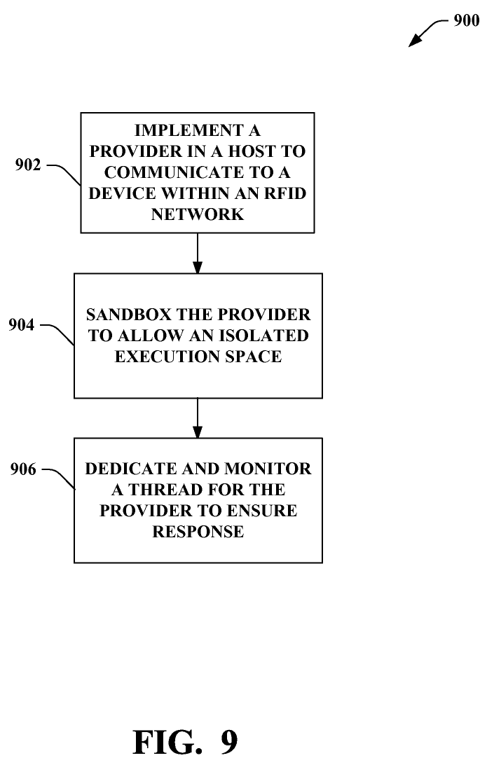

FIG. 9 illustrates a methodology 900 for employing a dedicated provider thread that is monitored by an RFID server. At reference numeral 902, a provider can be implemented in a host to communicate and/or talk to a device within an RFID network. It is to be appreciated that the devices can be at least one of the following: an RFID reader, an RFID writer, an RFID printer, a printer, a reader, a writer, an RFID transmitter, an antenna, a sensor, a real-time device, an RFID receiver, a real-time sensor, a device extensible to a web service, a real-time event generation, etc. The RFID network can be implemented by any enterprise, business, facility, and/or any suitable entity that can utilize RFID technology. For instance, the RFID network can be deployed to include any number of devices such as device ₁ to device _{N}, where N is positive integer. Moreover, such devices can interact (e.g., wirelessly communicate) with any number of tags such as tag ₁ to tag _{M}, where M is a positive integer.

At reference numeral 904, the provider can be sandboxed to allow for a respective and isolated execution space. It is to be appreciated that for each provider within the host communicating with the RFID server, such providers can be sandboxed at a granular level. By granularly sandboxing the providers, the faults and/or errors associated to providers can be independent of the host and/or RFID server and more so independent of other providers that do not have faults and/or errors.

At reference numeral 906, a dedicated thread can be employed for the providers to ensure responsiveness when control is transferred from a server code to the provider code. The RFID server threads may not be used to call into the provider. Rather, the RFID server threads can transfer control to the dedicated thread and monitor such thread for responsiveness. For instance, a ping, a time amount, etc. can be utilized to ensure the dedicated thread is still responsive. If there is no response, the dedicated thread can be abandoned and a timeout exception can be thrown. This can solve deadlock scenarios where user code calls back into the RFID server and attempts to take a lock through a call that has already been taken. Moreover, the deadlock scenarios can be further mitigated by the various components holding as granular locks as possible.

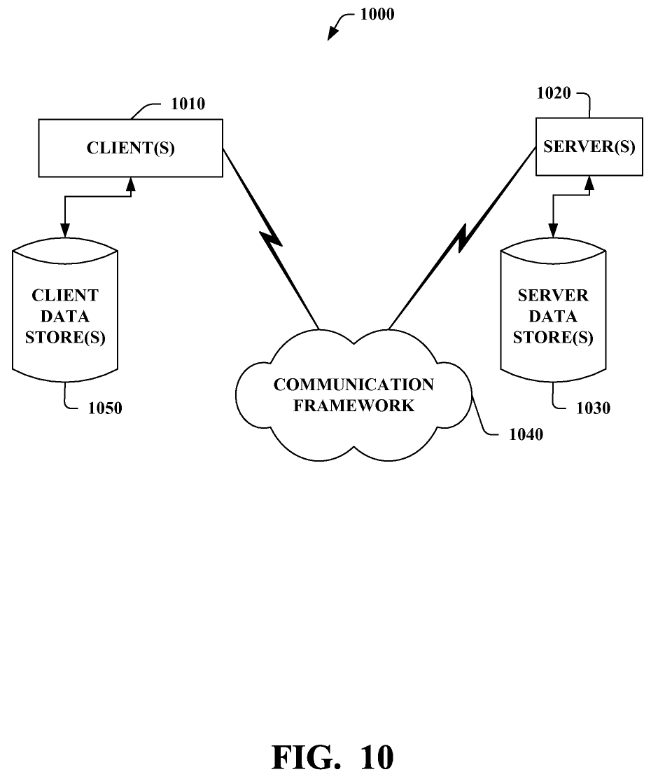

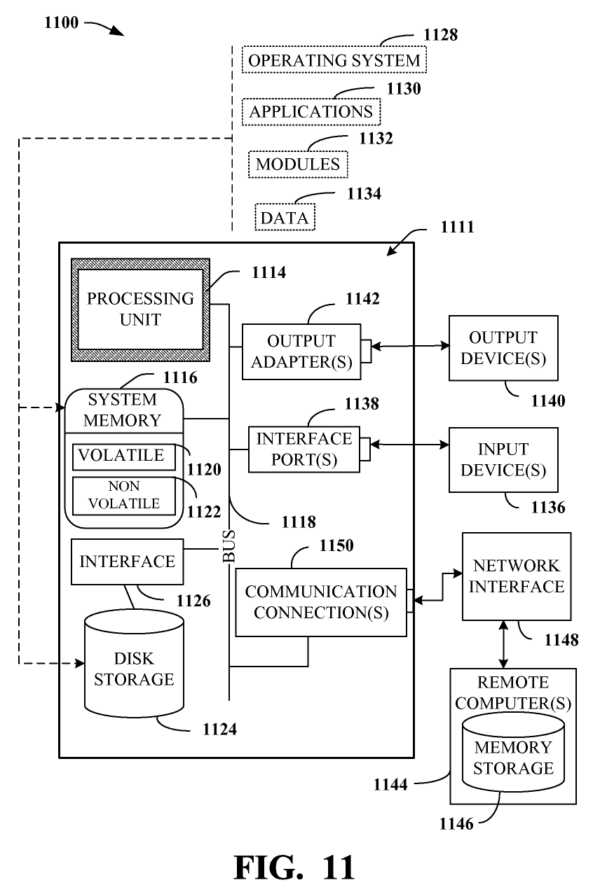

In order to provide additional context for implementing various aspects of the claimed subject matter, FIGS. 10-11 and the following discussion is intended to provide a brief, general description of a suitable computing environment in which the various aspects of the subject innovation may be implemented. For example, a provider manager that utilizes dedicated execution space in comparison to a host, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 10 is a schematic block diagram of a sample-computing environment 1000 with which the claimed subject matter can interact. The system 1000 includes one or more client(s) 1010. The client(s) 1010 can be hardware and/or software (e.g., threads, processes, computing devices). The system 1000 also includes one or more server(s) 1020. The server(s) 1020 can be hardware and/or software (e.g., threads, processes, computing devices). The servers 1020 can house threads to perform transformations by employing the subject innovation, for example.

One possible communication between a client 1010 and a server 1020 can be in the form of a data packet adapted to be transmitted between two or more computer processes. The system 1000 includes a communication framework 1040 that can be employed to facilitate communications between the client(s) 1010 and the server(s) 1020. The client(s) 1010 are operably connected to one or more client data store(s) 1050 that can be employed to store information local to the client(s) 1010. Similarly, the server(s) 1020 are operably connected to one or more server data store(s) 1030 that can be employed to store information local to the servers 1020.

With reference to FIG. 11, an exemplary environment 1100 for implementing various aspects of the claimed subject matter includes a computer 1112. The computer 1112 includes a processing unit 1114, a system memory 1116, and a system bus 1118. The system bus 1118 couples system components including, but not limited to, the system memory 1116 to the processing unit 1114. The processing unit 1114 can be any of various available processors. Dual microprocessors and other multiprocessor architectures also can be employed as the processing unit 1114.

The system bus 1118 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1116 includes volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable programmable ROM (EEPROM), or flash memory. Volatile memory 1120 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1112 also includes removable/non-removable, volatile/non-volatile computer storage media. FIG. 11 illustrates, for example a disk storage 1124. Disk storage 1124 includes, but is not limited to, devices like a magnetic disk drive, floppy disk drive, tape drive, Jaz drive, Zip drive, LS-100 drive, flash memory card, or memory stick. In addition, disk storage 1124 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to the system bus 1118, a removable or non-removable interface is typically used such as interface 1126.

It is to be appreciated that FIG. 11 describes software that acts as an intermediary between users and the basic computer resources described in the suitable operating environment 1100. Such software includes an operating system 1128. Operating system 1128, which can be stored on disk storage 1124, acts to control and allocate resources of the computer system 1112. System applications 1130 take advantage of the management of resources by operating system 1128 through program modules 1132 and program data 1134 stored either in system memory 1116 or on disk storage 1124. It is to be appreciated that the claimed subject matter can be implemented with various operating systems or combinations of operating systems.

A user enters commands or information into the computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port may be used to provide input to computer 1112, and to output information from computer 1112 to an output device 1140. Output adapter 1142 is provided to illustrate that there are some output devices 1140 like monitors, speakers, and printers, among other output devices 1140, which require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a personal computer, a server, a router, a network PC, a workstation, a microprocessor based appliance, a peer device or other common network node and the like, and typically includes many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1150 refers to the hardware/software employed to connect the network interface 1148 to the bus 1118. While communication connection 1150 is shown for illustrative clarity inside computer 1112, it can also be external to computer 1112. The hardware/software necessary for connection to the network interface 1148 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates providing reliability associated with radio frequency identification (RFID) technology, comprising:
an RFID network that includes at least one device that wirelessly receives data from a tag; and
a provider component that has a dedicated execution space independent of an RFID server within a host to communicate to at least one device within the RFID network.

2. The system of claim 1, the RFID network comprises a collection of devices that form a sub-system which includes:
an RFID reader that receives an RFID signal; and
an RFID tag that transmits to at least one device.

3. The system of claim 1, the device is one of the following: an RFID reader; an RFID writer; an RFID printer; a reader; a writer; an RFID transmitter; an antenna; a sensor; a real-time device; an RFID receiver; a real-time sensor; a device extensible to a web service; and a real-time event generation system.

4. The system of claim 1, further comprising a dedicated thread to transfer control from RFID server code to provider code.

5. The system of claim 4, further comprising a monitor component that ensures responsiveness of the dedicated thread.

6. The system of claim 5, the monitor component utilizes at least one of a ping and an amount of time to ensure responsiveness.

7. The system of claim 6, the monitor throws a timeout exception when the dedicated thread is abandoned.

8. The system of claim 7, the dedicated thread is abandoned when the provider component has at least one of the following: an error; a crash; a corruption; and a timeout.

9. The system of claim 4, the dedicated thread prevents a deadlock scenario.

10. The system of claim 9, the deadlock scenario is when a user code calls back into the RFID server and attempts to take a lock through a call that has already been taken.

11. The system of claim 9, the dedicated thread prevents the deadlock scenario by utilizing various components holding granular locks.

12. The system of claim 1, the provider component is associated with a particular device based on at least one of the following: a make; a model; a function; a type; a version; a size; a serial number; and a classification.

13. The system of claim 6, further comprising a provider manager within the RFID server that managers a plurality of provider components.

14. The system of claim 6, the plurality of provider components have respective RFID networks with at least one inclusive device.

15. The system of claim 1, further comprising a presentation component that provides at least one user interface to facilitate interaction between a user and the provider component.

16. The system of claim 1, the provider component is sandboxed within the host in comparison to the RFID server.

17. A computer-implemented method that facilitates improving the reliability associated with a radio frequency identification (RFID) technology, comprising:
implementing a provider in a host to communicate to a device within an RFID network; and
dedicating an execution domain for the provider independent of an RFID server within the host.

18. The method of claim 17, further comprising utilizing a dedicated thread to transfer control from the RFID server to the provider.

19. The method of claim 17, further comprising monitoring the thread to ensure responsiveness.

20. A computer-implemented system that facilitates improving the reliability associated with a radio frequency identification (RFID) technology, comprising:
means for wirelessly receiving data from a tag within a RFID network that includes at least one device; and
means for dedicating execution space for a provider component independent of an RFID server within a host to allow communication with the at least one device.
